(19) United States
(12) Patent Application Publication
(10) Pub. No.: US 2025/0223005 A1
(43) Pub. Date: Jul. 10, 2025

(54) Bottom Bracket Transmission with a Planetary Design for a Bicycle or Pedelec

(71) Applicant: ZF Friedrichshafen AG, Friedrichshafen (DE)

(72) Inventors: Stefan Beck, Eriskirch (DE); Johannes Kaltenbach, Friedrichshafen (DE); Michael Wechs, Weißensberg (DE); Mladjan Radic, Lonsee (DE); Peter Ziemer, Bad Woerishofen (DE); Thomas Riedisser, Sigmarszell (DE)

(21) Appl. No.: 18/852,674

(22) PCT Filed: Mar. 31, 2023
(86) PCT No.: PCT/EP2023/058441

§ 371 Date: Sep. 30, 2024

(30) Foreign Application Priority Data
Apr. 1, 2022 (DE) 10 2022 203 240.3

(51) Int. Cl. B62M 11/14; B62M 6/55; B62M 11/18; F16H 3/66

(52) U.S. Cl. CPC B62M 11/145; B62M 6/55; B62M 11/18; F16H 3/666; F16H 2200/201; F16H 2200/2069

(57) ABSTRACT

A bottom bracket gearbox includes a crank axle and a gearbox output shaft. The crank axle is connected to a second element of the first planetary gear set and connectable to a third element of the second planetary gear set via a fourth shift element and a second shaft. The gearbox output shaft is connected to a first element of the first planetary gear set and to a first element of the third planetary gear set. A third element of the first planetary gear set is connected to a second element of the second planetary gear set via a first shaft. A first element of the second planetary gear set is connected to a second element of the third planetary gear set via a third shaft. Two elements of the third planetary gear set are connectable via a fifth shift element to interlock the third planetary gear set.

### CROSS-REFERENCE TO RELATED APPLICATIONS

The present application is related and has right of priority to German Patent Application No. DE 102022203240.3 filed on Apr. 1, 2022, and is a U.S. national phase of PCT/EP2023/058441 filed on Mar. 31, 2023, both of which are incorporated by reference in their entireties for all purposes.

### TECHNICAL FIELD

The present invention relates generally to a bottom bracket gearbox of a planetary design for a bicycle or a pedelec. The invention further relates generally to a bicycle or a pedelec having the bottom bracket gearbox.

### BACKGROUND

For example, document DE 10 2016 225 169 A1 describes a gearbox of a planetary design for a bicycle or a pedelec. The gearbox includes at least two planetary gear sets in order to implement only four gears. Of these planetary gear sets, at least one planetary gear set is necessarily in the form of a positive planetary gear set, which requires a large amount of installation space. Furthermore, at least four shift elements are necessary. In one further embodiment variant of the gearbox, four further gears are obtained by adding two further shift elements and one further planetary gear set. Due to the provided interconnection, or connection, of the various planetary gear sets, the known gearbox has a design that requires a large amount of installation space.

### BRIEF SUMMARY

Example aspects of the present invention provide a bottom bracket gearbox of the aforementioned type, which requires as little installation space while having the few components.

Example aspects of the invention therefore relate to a bottom bracket gearbox of a planetary design for a bicycle or a pedelec. The bottom bracket gearbox has a crank axle as the input and a gearbox output shaft as the output, and at least four further shafts, the output preferably being implemented using a sprocket, a belt pulley, or the like. Furthermore, the bottom bracket gearbox has three planetary gear sets which are coaxial with the bottom bracket gearbox, and five shift elements for implementing at least six gears in the bottom bracket gearbox according to example aspects of the invention. In order to provide a particularly effective and installation space-favorable example embodiment of the bottom bracket gearbox, the crank axle is connected to a second element of the first planetary gear set. Furthermore, the crank axle is connectable to a third element of the second planetary gear set via a fourth shift element and a second shaft. The gearbox output shaft is connected to a first element of the first planetary gear set and to a first element of the third planetary gear set. A third element of the first planetary gear set is connected to a second element of the second planetary gear set via a first shaft. A first element of the second planetary gear set is connected to a second element of the third planetary gear set via a third shaft. In order to interlock the third planetary gear set, two elements of the third planetary gear set are connectable to each other via a fifth shift element.

In this way, the above-described connection of the only three provided planetary gear sets and the only five provided shift elements result in a particularly simple and compact configuration of the bottom bracket gearbox according to example aspects of the invention. This also results in particularly low component loads and an advantageously high gearing efficiency due to the geometric transmission ratio range in the bottom bracket gearbox.

Preferably in addition to the input and the output, only four further shafts or shaft-like elements are used in order to mechanically connect elements of the planetary gear sets. The term “shaft” is not to be understood exclusively as a cylindrical, rotatably mounted machine element for transmitting torques, but is rather also to be understood as general connecting elements that connect the individual gear set elements to one another for torque transmission.

In order to achieve the installation space-favorable arrangement in the bottom bracket gearbox according to example aspects of the invention, when the first shift element is engaged, the second shaft, which is connected to the third element of the first planetary gear set, is fixedly connected to a housing, when the second shift element is engaged, the third shaft, which is connected to the first element of the second planetary gear set and to the second element of the third planetary gear set, is fixedly connected to the housing, and, when the third shift element is engaged, a fourth shaft, which is connected to the third element of the third planetary gear shaft, is fixedly connected to the housing. Due to the above-described housing-side connection of the elements by the provided shift elements as brakes, the intended gears can be implemented in combination with a highly compact design of the bottom bracket gearbox.

Within the framework of example aspects of the present invention, in the bottom bracket gearbox according to example aspects of the invention, the first shift element, the second shift element, and the third shift element are each in the form of an interlocking brake and/or the fourth shift element and the fifth shift element are each in the form of a freewheel unit.

The shift elements in the form of brakes are preferably in the form of interlocking shift elements, for example, low-cost shifting dogs or the like, for example, having a toothed brake ring and a corresponding shift pawl. Brakes as shift elements have the advantage that these are readily accessible from the outside for actuation. Since the provided freewheel units are used as clutches, it is advantageous when the brakes are in the form, for example, of single-sided brakes in order to prevent the gearbox from interlocking when the direction of rotation reverses at the input or at the output.

Preferably, permanently engaged freewheel units are used as freewheel units. This has the advantage that no engagement is necessary with the passive shift elements. The permanently engaged freewheel unit transmits a torque when this freewheel unit is interlocked. No torque is transmitted in the opposite direction of rotation. It is conceivable, however, that engageable and disengageable freewheel units or even engageable and disengageable freewheel brakes are used.

In the bottom bracket gearbox according to example aspects of the invention, in order to interlock the third planetary gear set, within the framework of a first interlock variant, the first element of the third planetary gear set is connectable to the third element of the third planetary gear set via the fifth shift element. Furthermore, within the framework of a second interlock variant, the first element of the third planetary gear set is connectable to the second element of the third planetary gear set via the fifth shift element. In addition, within the framework of a third interlock variant, the second element of the third planetary gear set is connectable to the third element of the third planetary gear set via the fifth shift element.

A preferred example embodiment of the invention can provide that at least one of the provided planetary gear sets is in the form of a negative planetary gear set, whereby a particularly installation space-favorable arrangement results. It is also conceivable that one of the planetary gear sets is in the form of a positive planetary gear set.

A negative planetary gear set can preferably be converted into a positive planetary gear set when the planet carrier connection and the ring gear connection to this gear set are interchanged with one another and the value of the stationary transmission ratio is increased by one (1). A negative planetary gear set has planet gears, which are rotatably mounted on the planet carrier of and mesh with the sun gear and the ring gear of this planetary gear set, such that, when the planet carrier is held and the sun gear rotates, the ring gear rotates in the direction that is opposite the direction of rotation of the sun gear. A positive planetary gear set has inner and outer planet gears, which are rotatably mounted on its planet carrier and are in tooth engagement with one another, wherein the sun gear of this planetary gear set meshes with the inner planet gears, and the ring gear of this planetary gear set meshes with the outer planet gears, such that, when the planet carrier is held and the sun gear rotates, the ring gear rotates in the same direction of rotation as the sun gear.

For a person skilled in the art, this means that, in the single gear sets in the form of a negative planetary gear set, a first element is in the form of a sun gear, a second element is in the form of a planet carrier, or a planet carrier, and a third element is in the form of a ring gear. Furthermore, this means that, in the case of a single gear set in the form of a positive planetary gear set, the first element is in the form of a sun gear, the second element is in the form of a ring gear, and the third element is in the form of a planet carrier.

In order to further optimize the control of the bottom bracket gearbox according to example aspects of the invention, at least one torque sensor or the like is provided at the input and/or at the output.

In order to electrically support the input in the bottom bracket gearbox according to example aspects of the invention, at least one electric machine or the like can be connected or connectable, or fixedly or detachably coupled, to the input, or to the crank axle and/or to the output, or to the gearbox output shaft. Preferably, the electric machine can be arranged axially parallel to the crank axle.

One further example aspect of the present invention is directed to a bicycle or a pedelec having the above-described bottom bracket gearbox. This yields the above-described advantages and further advantages.

### BRIEF DESCRIPTION OF THE DRAWINGS

Example aspects of the present invention are explained in greater detail in the following with reference to the drawings, wherein:

FIG. 1 shows a schematic basic view of one possible example embodiment variant of a bottom bracket gearbox of a planetary design for a bicycle or a pedelec;

FIG. 2 shows a schematic basic view of the bottom bracket gearbox with a first interlock variant in a third planetary gear set;

FIG. 3 shows a schematic basic view of the bottom bracket gearbox with a second interlock variant in the third planetary gear set;

FIG. 4 shows a schematic basic view of the bottom bracket gearbox shown in FIG. 1 with a positive planetary gear set in the form of a first planetary gear set by way of example;

FIG. 5 shows a schematic basic view of the bottom bracket gearbox shown in FIG. 1 with a positive planetary gear set in the form of a second planetary gear set by way of example;

FIG. 6 shows a schematic basic view of the bottom bracket gearbox shown in FIG. 1 with a positive planetary gear set in the form of a third planetary gear set by way of example;

FIG. 7 shows a schematic view of the bottom bracket gearbox shown in FIG. 1 with a torque sensor at the input, which is indicated by way of example;

FIG. 8 shows a schematic view of the bottom bracket gearbox shown in FIG. 1 with an electric machine arranged at the input, which is indicated by way of example;

FIG. 9 shows a schematic view of the bottom bracket gearbox shown in FIG. 1 with an electric machine arranged at the output by way of example; and

FIG. 10 shows a gear shift matrix with the engageable and disengageable gears in the bottom bracket gearbox according to example aspects of the invention, according to FIGS. 1 through 9.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

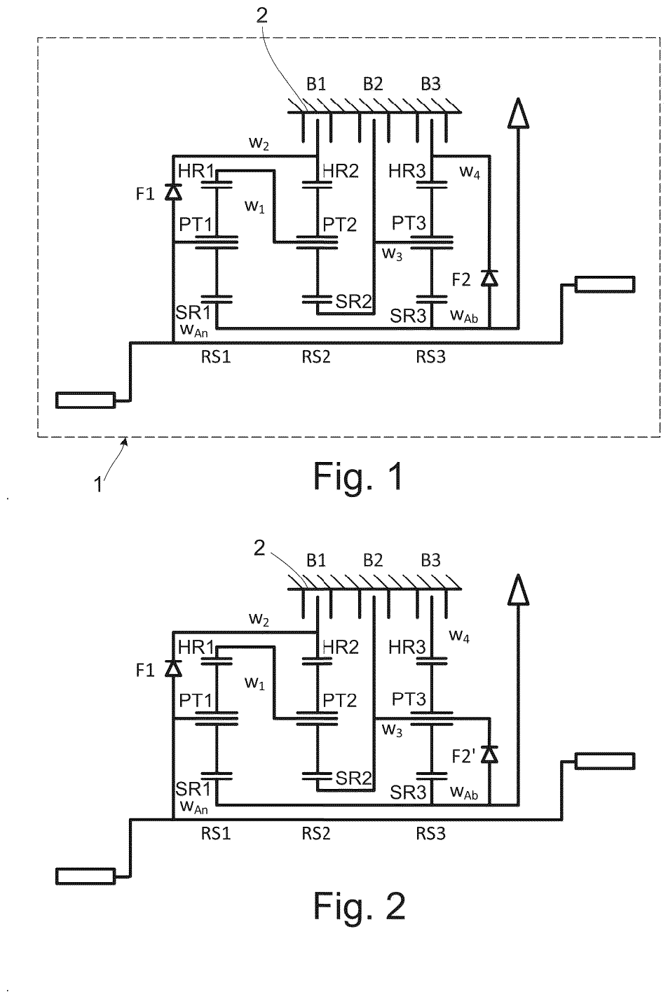

FIGS. 1 through 9 show various embodiments with reference to schematic basic views of a bottom bracket gearbox according to example aspects of the invention of a planetary design for a bicycle or a pedelec 1 merely by way of example. FIG. 1 shows the schematically indicated bicycle or pedelec 1 with the bottom bracket gearbox.

Regardless of the example embodiments, the bottom bracket gearbox includes, in a housing, or bottom bracket housing 2, a crank axle, or pedal crank, Wₐₙ as the input with the pedals, and a gearbox output shaft W_{ab} as the output with a sprocket, or belt pulley (not shown in greater detail). Furthermore, four further shafts W₁, W₂, W₃, W₄ are provided, which are coupled, or connected, to the elements of the three planetary gear sets RS1, RS2, RS3. The elements of the first planetary gear set RS1 and of the second planetary gear set RS2 and of the third planetary gear set RS3 are coaxial with the crank axle Wₐₙ. In addition, five shift elements B1, B2, B3, F1, F2, F2′, F2″ are provided for implementing six gears V1, V2, V3, V4, V5, V6. The first shift element B1 and the second shift element B2 as well as the third shift element B3 are each in the form of a switchable brake, while the fourth shift element F1 and the fifth shift element F2 are each in the form of permanently engaged freewheel units.

Furthermore, regardless of the example embodiments, in the bottom bracket gearbox according to example aspects of the invention, the crank axle Wₐₙ is connected to a second element of the first planetary gear set RS1, the crank axle Wₐₙ being connectable to a third element of the second planetary gear set RS2 via a fourth shift element F1 and a second shaft W₂. Consequently, when the fourth shift element F1 is interlocked, the crank axle Wₐₙ is connected to the second shaft W₂. The gearbox output shaft W_{ab} is connected to a first element of the first planetary gear set RS1 and to a first element of the third planetary gear set RS3, a third element of the first planetary gear set RS1 being connected to a second element of the second planetary gear set RS2 via a first shaft W₁, a first element of the second planetary gear set RS2 being connected to a second element of the third planetary gear set RS3 via a third shaft W₃, and two elements of the third planetary gear set RS3 being connectable to each other via a fifth shift element F2, F2′, F2″ to interlock the third planetary gear set RS3.

The above-described connection of the elements of the planetary gear sets RS1, RS2, RS3 and of the shafts W_{ab}, W_{ab}, W₁, W₂, W₃, W₄ and of the shift elements B1, B2, B3, F1, F2, F2′, F2″ results in a particularly installation space-favorable example embodiment of the bottom bracket gearbox.

In FIGS. 1 through 3 and 7 through 9, the three provided planetary gear sets RS1, RS2, RS3 are each in the form of an installation space-favorable negative planetary gear set. A sun gear SR1, SR2, SR3 is provided as the first element, a planet carrier PT1, PT2, PT3 is provided as the second element, and a ring gear HR1, HR2, HR3 is provided as the third element in the planetary gear sets RS1, RS2, RS3, respectively.

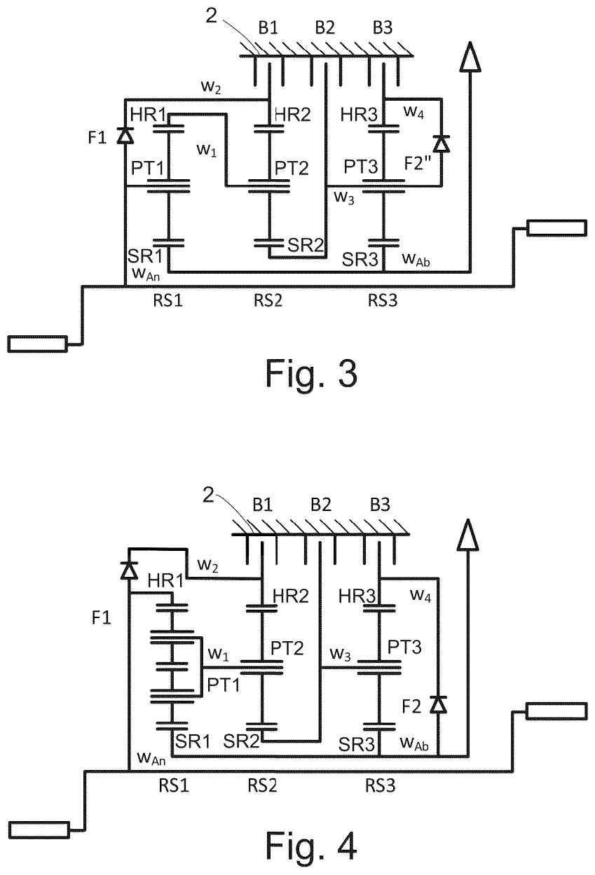

In detail, as a result, the crank axle Wₐₙ is connected to the planet carrier PT1 of the first planetary gear set RS1. Furthermore, the crank axle Wₐₙ is connectable to the ring gear HR2 of the second planetary gear set RS2 via the fourth shift element F₁, which is in the form of a freewheel unit. The gearbox output shaft W_{ab} is connected to the sun gear SR1 of the first planetary gear set RS1 and to the sun gear SR3 of the third planetary gear set RS3. The ring gear HR1 of the first planetary gear set RS1 is connected to the planet carrier PT2 of the second planetary gear set RS2 via the first shaft W₁. Furthermore, the sun gear SR2 of the second planetary gear set RS2 is connected to the planet carrier PT3 of the third planetary gear set RS3 via the third shaft W₃. In order to interlock the third planetary gear set RS3, as a first interlock variant, the sun gear SR3 is connectable to the ring gear HR3 via the fifth shift element F2, which is in the form of a freewheel unit, or, as a second interlock variant, the sun gear SR3 is connectable to the planet carrier PT3 via the fifth shift element F2′, which is in the form of a freewheel unit, or, as a third interlock variant, the ring gear HR3 is connectable to the planet carrier PT3 via the fifth shift element F2″, which is in the form of a freewheel unit. FIG. 1 shows the first interlock variant, while FIG. 2 shows the second interlock variant and FIG. 3 shows the third interlock variant.

When the first shift element B1 in the form of a brake is engaged, the ring gear HR2 of the second planetary gear set RS2 is fixedly connected to the housing 2 via the second shaft W₂. When the second shift element B2 in the form of a brake is engaged, the sun gear SR2 of the second planetary gear set RS2 and the planet carrier PT3 of the third planetary gear set RS3 are fixedly connected to the housing 2 via the third shaft W₃. When the third shift element B3 in the form of a brake is engaged, the ring gear HR3 of the third planetary gear set RS3 is fixedly connected to the housing 2 via the fourth shaft W₄. When the fourth shift element F1 in the form of a freewheel unit is interlocked, the crank axle Wₐₙ is connected to the second shaft W₂. When the fifth shift element F2 in the form of a freewheel unit is interlocked, the gearbox output shaft W_{ab} is connected to the fourth shaft W₄ and the third planetary gear set RS3 is interlocked.

In FIGS. 4 through 6, a positive planetary gear set is always provided in each of the three provided planetary gear sets RS1, RS2, RS3. In the positive planetary gear set, the ring gear connection and the planet carrier connection are interchanged.

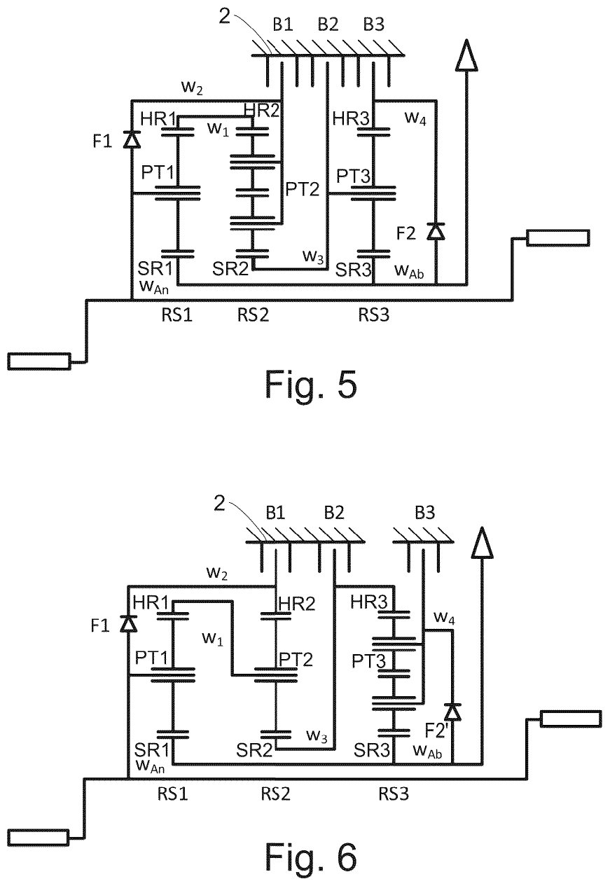

In FIG. 4, for example, the first planetary gear set RS1 is in the form of a positive planetary gear set, while the second planetary gear set RS2 and the third planetary gear set RS3 are each in the form of a negative planetary gear set. In FIG. 5, for example, the second planetary gear set RS2 is in the form of a positive planetary gear set, while the first planetary gear set RS1 and the third planetary gear set RS3 are each in the form of a negative planetary gear set. In FIG. 6, for example, the third planetary gear set RS3 is in the form of a positive planetary gear set, while the first planetary gear set RS1 and the second planetary gear set RS2 are each in the form of a negative planetary gear set. The use of a positive planetary gear set results in greater flexibility in the selection of the transmission ratios.

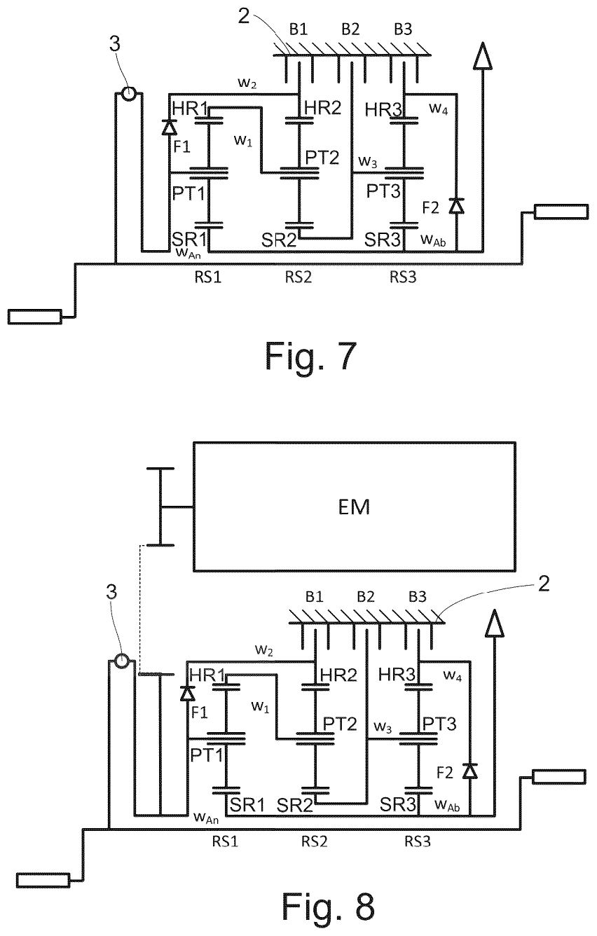

FIG. 7 shows an example embodiment of the bottom bracket gearbox according to example aspects of the invention, in which a torque sensor 3 is connected, or connectable, to the crank axle Wₐₙ. For example, a disk-shaped torque sensor 3 can be arranged at the gearbox input. The torque sensor 3 can also have a different embodiment, however.

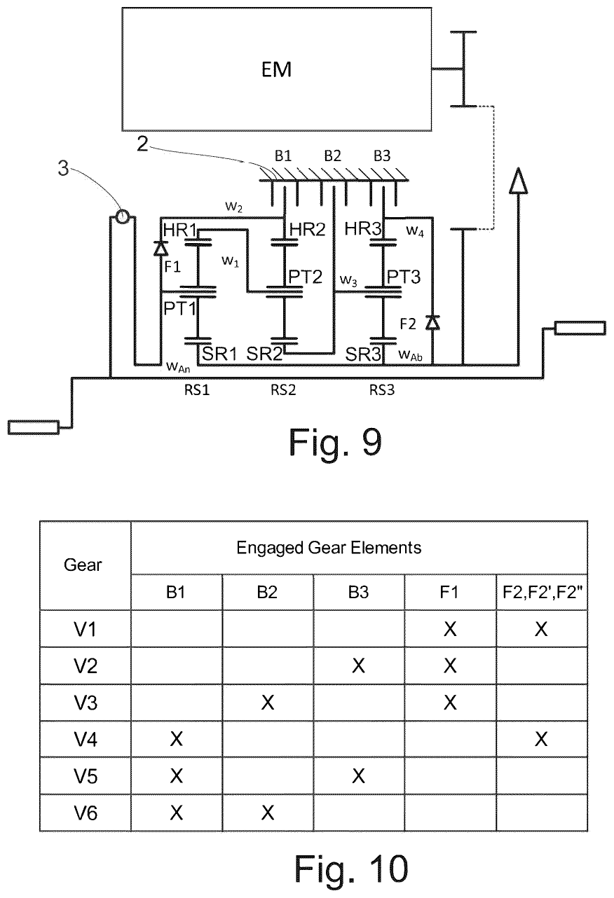

FIGS. 8 and 9 each show an example embodiment of the bottom bracket gearbox according to example aspects of the invention with an additional electric machine EM. The electric machine EM can be connected to the crank axle Wₐₙ, as indicated in FIG. 8. It is also conceivable that the electric machine EM is connected to the gearbox output shaft W_{ab}, as indicated in FIG. 9. The electric machine EM is preferably arranged axially parallel to the crank axle Wₐₙ. A coaxial arrangement of the electric machine EM with the crank axle Wₐₙ would also be possible, however. Regardless thereof, it is advantageous to connect the electric machine EM via a freewheel unit or the like, so that, during operation without the electric machine EM, no losses are caused by the rotating electric machine EM.

FIG. 10 shows, by way of example, a gear shift matrix for the example embodiments of the bottom bracket gearbox according to example aspects of the invention, which are shown in FIGS. 1 through 9. In the gear shift matrix, shift elements B1, B2, B3, F1, F2, F2′, F2″ are indicated for the respective gear V1, V2, V3, V4, V5, V6. An “X” for a freewheel unit F1, F2, F2′, F2″ as a shift element in the gear shift matrix means that the freewheel unit is interlocked. This functions automatically without external actuation. Furthermore, an “X” for a brake B1, B2, B3 as a shift element in the gear shift matrix means that the brake B1, B2, B3 is engaged. This functions via a suitable actuator system.

Specifically, the gear shift matrix according to FIG. 10 indicates that, in order to implement a first gear V1, the fourth shift element F1 in the form of a freewheel unit and the fifth shift element F2, F2′, F2″ in the form of a freewheel unit are interlocked, in order to implement a second gear V2, the third shift element B3 in the form of a brake is engaged and the fourth shift element F1 in the form of a freewheel unit is interlocked, in order to implement a third gear V3, the second shift element B2 in the form of a brake is engaged and the fourth shift element F1 in the form of a freewheel unit is interlocked, in order to implement a fourth gear V4, the first shift element B1 in the form of a brake is engaged and the fifth shift element F2, F2′, F2″ in the form of a freewheel unit is interlocked, in order to implement a fifth gear V5, the first shift element B1 in the form of a brake and the third shift element B3 in the form of a brake are engaged, and/or in order to implement a sixth gear V6, the first shift element B1 in the form of a brake and the second shift element B2 in the form of a brake are engaged. As a result, only two shift elements need to be used at the same time to shift a gear.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 bicycle or a pedelec
2 housing or bottom bracket housing
3 torque sensor
SR1 sun gear of the first planetary gear set
PT1 planet carrier of the first planetary gear set
HR1 ring gear of the first planetary gear set
SR2 sun gear of the second planetary gear set
PT2 planet carrier of the second planetary gear set
HR2 ring gear of the second planetary gear set
SR3 sun gear of the third planetary gear set
PT3 planet carrier of the third planetary gear set
HR3 ring gear of the third planetary gear set
Wₐₙ crank axle
W_{ab} gearbox output shaft
EM electric machine
W₁ first shaft
W₂ second shaft
W₃ third shaft
W₄ fourth shaft
RS1 first planetary gear set
RS2 second planetary gear set
RS3 third planetary gear set
B1 first shift element as brake
B2 second shift element as brake
B3 third shift element as brake
F1 fourth shift element as freewheel unit
F2,F2′,F2′ fifth shift element as freewheel unit
V1 first gear
V2 second gear
V3 third gear
V4 fourth gear
V5 fifth gear
V6 sixth gear

1-15. canceled

16. A bottom bracket gearbox for a bicycle or a pedelec (1), comprising:
a crank axle (Wₐₙ) as an input;
a gearbox output shaft (W_{ab}) as an output;
a first shaft (W₁), a second shaft (W₂), a third shaft (W₃), and a fourth shaft (W₄);
a first planetary gear set (RS1), a second planetary gear set (RS2), and a third planetary gear set (RS3) arranged coaxial with the crank axle (Wₐₙ); and
a first shift element (B1), a second shift element (B2), a third shift element (B3), a fourth shift element (F1), and a fifth shift element (F2, F2′, F2″) for implementing at least six gears (V1, V2, V3, V4, V5, V6),
wherein the crank axle (Wₐₙ) is connected to a second element of the first planetary gear set (RS1), and the crank axle (Wₐₙ) is connectable to a third element of the second planetary gear set (RS2) via the fourth shift element (F1) and the second shaft (W₂),
wherein the gearbox output shaft (W_{ab}) is connected to a first element of the first planetary gear set (RS2) and to a first element of the third planetary gear set (RS3),
wherein a third element of the first planetary gear set (RS1) is connected to a second element of the second planetary gear set (RS2) via the first shaft (W₁),
wherein a first element of the second planetary gear set (RS2) is connected to a second element of the third planetary gear set (RS3) via the third shaft (W₃), and
wherein two elements of the third planetary gear set (RS3) are connectable to each other via the fifth shift element (F2, F2′, F2″) to interlock the third planetary gear set (RS3).

17. The bottom bracket gearbox of claim 16, wherein:
the second shaft (W₂) is fixedly connected to a housing (2) when the first shift element (B1) is engaged, and the second shaft (W₂) is connected to the third element of the first planetary gear set (RS1) when the first shift element (B1) is engaged;
the third shaft (W₃) is fixedly connected to the housing (2) when the second shift element (B2) is engaged, and the third shaft (W₃) is connected to the first element of the second planetary gear set (RS2) and to the second element of the third planetary gear set (RS3) when the second shift element (B2) is engaged; and
a fourth shaft (W₄) is fixedly connected to the housing (2) when the third shift element (B3) is engaged, and the fourth shaft (W₄) is connected to the third element of the third planetary gear set (RS3) when the third shift element (B3) is engaged.

18. The bottom bracket gearbox of claim 16, wherein one or both of:
the first shift element (B1), the second shift element (B2), and the third shift element (B3) are each a respective interlocking brake; and
the fourth shift element (F1) and the fifth shift element (F2, F2′, F2″) are each a respective freewheel unit.

19. The bottom bracket gearbox of claim 16, further comprising a torque sensor (3) connected to the crank axle (Wₐₙ).

20. The bottom bracket gearbox of claim 16, further comprising an electric machine (EM) connected or connectable to the crank axle (Wₐₙ) or to the gearbox output shaft (W_{ab}).

21. The bottom bracket gearbox of claim 20, wherein the electric machine (EM) arranged axially parallel to the crank axle (WAN).

22. The bottom bracket gearbox of claim 16, wherein, to interlock the third planetary gear set (RS3), the first element of the third planetary gear set (RS3) is connectable to the third element of the third planetary gear set (RS3) via the fifth shift element (F2).

23. The bottom bracket gearbox of claim 16, wherein, to interlock the third planetary gear set (RS3), the first element of the third planetary gear set (RS3) is connectable to the second element of the third planetary gear set (RS3) via the fifth shift element (F2′).

24. The bottom bracket gearbox of claim 16, wherein, to interlock the third planetary gear set (RS3), the second element of the third planetary gear set (RS3) is connectable to the third element of the third planetary gear set (RS3) via the fifth shift element (F2″).

25. The bottom bracket gearbox of claim 16, wherein one or more of the first, second, and third planetary gear sets (RS1, RS2, RS3) is a respective negative planetary gear set.

26. The bottom bracket gearbox of claim 25, wherein, in each negative planetary gear set, the first element is a sun gear (SR1, SR2, SR3), the second element is a planet carrier (PT1, PT2, PT3), and the third element is a ring gear (HR1, HR2, HR3).

27. The bottom bracket gearbox of claim 16, wherein one or more of the first, second, and third planetary gear sets (RS1, RS2, RS3) is a respective positive planetary gear set.

28. The bottom bracket gearbox of claim 27, wherein, in each positive planetary gear set, the first element is a sun gear (SR1, SR2, SR3), the second element is a ring gear (HR1, HR2, HR3), and the third element is a planet carrier (PT1, PT2, PT3).

29. The bottom bracket gearbox of claim 16, wherein one or more of:
the fourth shift element (F1) is interlocked and the fifth shift element (F2, F2′, F2″) is interlocked to implement a first gear (V1) of the at least six gears (V1, V2, V3, V4, V5, V6), and each of the fourth shift element (F1) and the fifth shift element (F2, F2′, F2″) is a respective freewheel unit;
the third shift element (B3) is engaged and the fourth shift element (F1) is interlocked to implement a second gear (V2) of the at least six gears (V1, V2, V3, V4, V5, V6), the third shift element (B3) is a brake, and the fourth shift element (F1) is a freewheel unit;
the second shift element (B2) is engaged and the fourth shift element (F1) is interlocked to implement a third gear (V3) of the at least six gears (V1, V2, V3, V4, V5, V6), the second shift element (B2) is a brake, and the fourth shift element (F1) is a freewheel unit;
the first shift element (B1) is engaged and the fifth shift element (F2, F2′, F2″) is interlocked to implement a fourth gear (V4) of the at least six gears (V1, V2, V3, V4, V5, V6), the first shift element (B1) is a brake, and the fifth shift element (F2, F2′, F2″) is a freewheel unit;
the first shift element (B1) is engaged and the third shift element (B3) is engaged in order to implement a fifth gear (V5) of the at least six gears (V1, V2, V3, V4, V5, V6), and each of the the first shift element (B1) and the third shift element (B3) is a respective brake; and
the first shift element (B1) is engaged and the second shift element (B2) is engaged to implement a sixth gear (V6) of the at least six gears (V1, V2, V3, V4, V5, V6), and each of the the first shift element (B1) and the second shift element (B2) is a respective brake.

30. A bicycle or pedelec (1), comprising the bottom bracket gearbox of claim 16.
